(19) United States
(12) Patent Application Publication
(10) Pub. No.: US 2017/0350285 A1
(43) Pub. Date: Dec. 7, 2017

(54) Valve for Controlling a Gas Stream, Liquid Separator, Venting System and Internal Combustion Engine Having Such a Valve

(71) Applicant: REINZ-DICHTUNGS-GMBH, NEU-ULM (DE)

(72) Inventors: CHRISTOPH ERDMANN, ULM (DE); PETR POLEDNAK, NEU-ULM (DE); FRANCESCO ZITAROSA, ILLERTISSEN (DE)

(21) Appl. No.: 15/539,407

(22) PCT Filed: Dec. 15, 2015
(86) PCT No.: PCT/EP2015/079899

§ 371 Date: Jun. 23, 2017

(30) Foreign Application Priority Data
Dec. 23, 2014 (DE) 20 2014 106 257.2

(51) Int. Cl. F01M 13/00; F16K 17/04; F16K 1/20; F02M 25/06; F16K 15/03; F16K 27/02; F16K 15/14

(52) U.S. Cl. CPC F01M 13/0011; F16K 27/0227; F16K 17/0413; F16K 15/147; F02M 25/06; F16K 15/031; F16K 1/2035; F16K 15/033

(57) ABSTRACT

A valve for controlling a gas stream between a first side and a second side of the valve is described. A valve opening is passage for the gas stream between the first side and the second side. A valve closure with a valve plate closes the valve opening. A valve mount is arranged toward the second side and on which the valve closure is mounted. The valve closure is pretensioned in the direction of the first side to close the valve toward the second side by the valve plate. The valve plate has an opening element which can be opened toward the first side in the event of an overpressure on the second side.

The present invention relates to a valve for controlling a gas flow. Furthermore, it relates to a liquid separator, a ventilation system and also an internal combustion engine, which include such a valve.

In the crankcase of an internal combustion engine, blow-by gases occur which are guided normally, in particular for environmental reasons, into the intake duct of the internal combustion engine. For guiding the blow-by gases out of the crankcase into the intake duct, the pressure difference between the crankcase and the intake duct is used.

A ventilation system for a crankcase for transporting blow-by gases therefore normally has a ventilation pipe from the crankcase to the intake pipe. In the ventilation pipe, usually an oil separator/oil mist separator is disposed in addition in order to separate oil and oil mist, which are contained in the blow-by gases, from the blow-by gases.

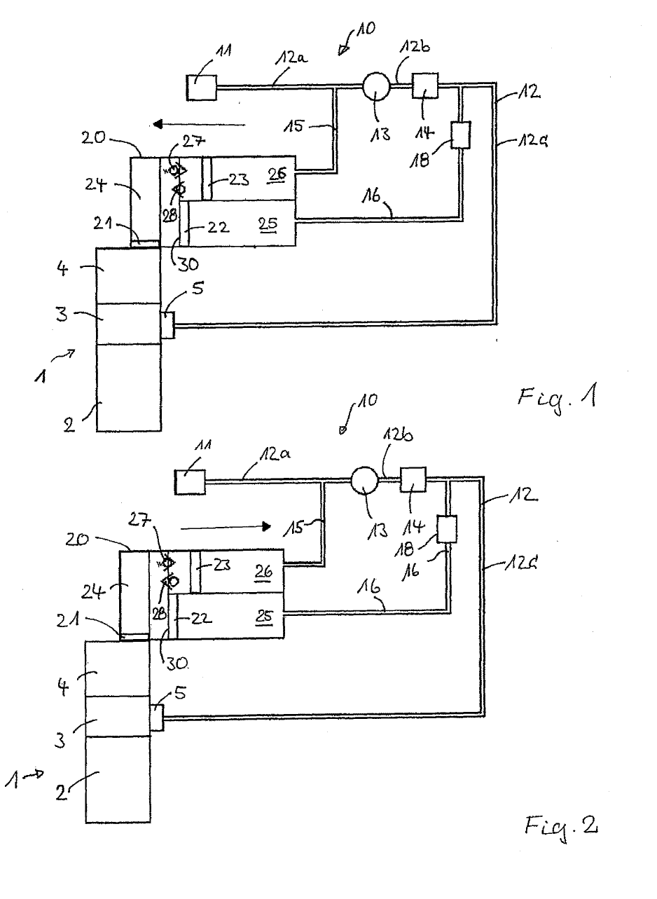

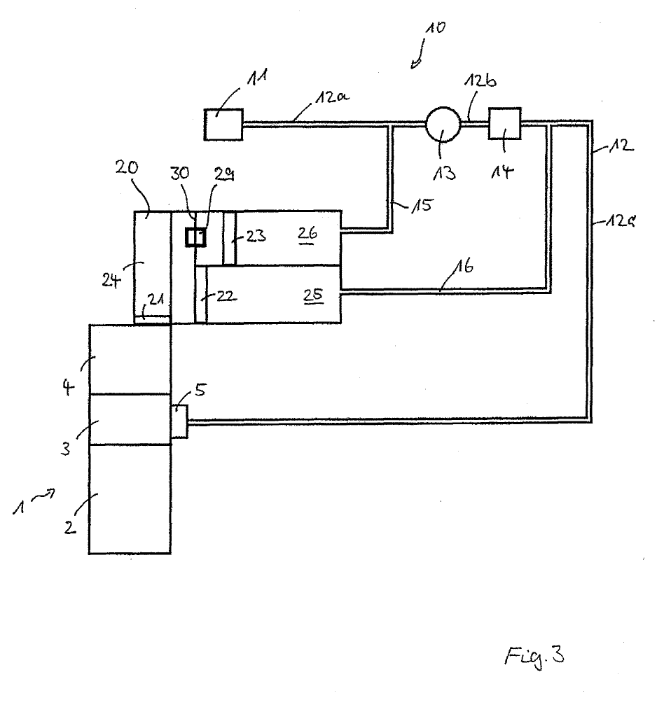

FIGS. 1 and 2 show a combustion engine as an internal combustion engine in schematic cross-section. The internal combustion engine 1 has a crankcase 2, a cylinder head 3 and also a cylinder head cover/valve cover 4. Furthermore, the internal combustion engine 1 has an intake duct 10 with an air filter 11, a charger device 13, for example a turbocharger or a compressor, a throttle valve 14 and an intake pipe 12, connecting these, with pipe sections 12a, 12b and 12c. The intake pipe 12 leads from the air filter 11 via the charger device 13 and the throttle valve 14 to an intake manifold 5.

In or on the valve cover 4, a coarse oil separator 21 which serves for separation of oil or oil mist is disposed. The coarse oil separator 21 is flowed through by the blow-by gases. These are conducted, for this purpose, from the crankcase 2 either externally or via the cylinder head 3 and/or the valve cover 4 in the direction of the antechamber 20. There they flow firstly through the coarse oil separator 21. They enter via the coarse separator 21 into a pressure-side settling chamber 24 which, together with the coarse oil separator 21, forms the antechamber 20.

FIG. 1 shows this engine in coasting operation. In this state, just as in partial load operation, the blow-by gases flow from the settling chamber 24 via a suction-side postchamber 25, in which a further oil separator 22 is disposed, and a ventilation pipe 16 to the intake pipe 12c between throttle valve 14 and intake manifold 5. Ventilation via the suction-side chamber 25 and the ventilation pipe 16 serves for ventilation of the crankcase in partial load operation or coasting operation of the engine because, in partial load operation and in coasting operation, a negative pressure is present in the intake pipe 12c relative to the crankcase 2 so that the blow-by gases are guided through the oil separator 22. For protection against uncontrolled pressure peaks, a pressure control valve 18 is disposed in the ventilation pipe 16.

Whilst in partial load operation, a relatively large volume flow of blow-by gases must be guided from the crankcase to the intake duct, this volume flow is very low in coasting operation. Rather in the case of a closed throttle valve 14, the pipe sections 15 and 16 are scoured via the chambers 26, 20 and 25. In order to make this possible, a bypass valve 27 is provided between the chamber 26 and the chamber 20, which valve opens with increased volume flow from the chamber 26 and hence increased pressure in the chamber 26 relative to the chamber 20. The non-return valve 28 disposed parallel to the bypass valve 27 is closed in this state.

Parallel to the first-mentioned flow path via the oil separator 22 and the pressure-side chamber 25, a further oil separator 23 and a suction-side chamber 26 are therefore disposed. Both suction-side chambers 25 and 26 are connected to the antechamber 20. Starting from the suction-side chamber 26, a ventilation pipe 15 leads to the section 12a of the intake pipe 12 between air filter 11 and charger device 13. This pipe section is used in coasting operation, as already mentioned, for conducting fresh air in the direction of the chamber 20.

In reverse flow direction, a ventilation valve 28 is disposed in front of the oil separator 23, which ventilation valve opens in the case of sufficient low pressure in the intake pipe 12 in the region in front of the charger device 13, i.e. in the pipe section 12a. This is the case in full-load operation, as illustrated in FIG. 2. This means that, at very low pressure in the intake pipe 12a relative to the settling chamber 24, this valve 28 opens as ventilation valve and enables a direct flow of blow-by gases from the crankcase 2 to the intake pipe 12a of the intake duct 10. The bypass valve 27 is closed in this state.

In order therefore to ensure both reliable ventilation during coasting operation, as in FIG. 1, and reliable ventilation during full load as in FIG. 2, two different valves 27 and 28, which are disposed parallel in the flow direction of the gases, are required. Installation of two different valves requires however constructional space, assembly complexity and costs.

Starting from this state of the art, it is now the object of the present invention to make available a valve arrangement which is optimised with respect to constructional space. At the same time, this valve arrangement is intended to fulfil the above-described functions reliably. Furthermore, it is the object of the present invention to make available a liquid separator, a ventilation system and an internal combustion engine which are optimised with respect to the required constructional space.

This object is achieved by the valve according to claim 1, the liquid separator according to claim 20, the ventilation system according to claim 21 and also the internal combustion engine according to claim 22. Advantageous developments of the valve according to the invention are indicated in the associated dependent claims.

According to the invention, a valve for controlling a gas flow between the two sides of the valve is now made available. The valve has, like any conventional valve, a valve opening and a valve closure. The valve closure has a valve plate with which the valve opening can be closed. Furthermore, the valve closure is mounted on a valve bearing such that it is pretensioned in the direction for closure of the valve by means of the valve plate. As a result of this mounting of the valve closure which is pretensioned and resilient, the valve closure is closed in the case of absence of low pressure on the side behind the valve bearing of the valve viewed from the valve plate.

According to the invention, the valve plate is now provided with an opening element. The opening element now opens counter to the opening direction of the valve plate.

Whilst therefore the valve plate opens, in the case of overpressure, on a first side of the valve relative to the second side of the valve, and thus enables a gas flow through the valve opening, the opening element opens in the case of high pressure on the second side of the valve relative to the first side of the valve. Consequently, it becomes possible to provide the valve not only with a ventilation function but, simultaneously, also with a bypass function.

Whilst the valve plate is however mounted with pretension, the opening element can be used without or with pretension or without or with pretension counter to the closing direction of the opening element.

By means of the valve according to the invention, now two contrary valve functions are integrated in a single component. It is therefore advantageous with such a combination valve that it can fulfil two functions: firstly, passage through the valve in one direction with a definable differential pressure is possible and, at the same time, also opening in the other direction with a likewise definable differential pressure is possible.

For opening of the valve plate, differential pressures between 0 and 500 mbar are particularly suitable, advantageously between 0 and 100 mbar, respectively including or also excluding the boundary values. For opening of the opening element, differential pressures between 0 and 500 mbar are particularly suitable, advantageously between 0 and 200 mbar, respectively including or also excluding the boundary values.

By adjusting the differential pressures, it is therefore possible to produce a passage in one direction and a deliberate bypass in the other direction of the valve. It is not necessary now to provide separate valves for these two functions. Consequently, the valve according to the invention is more economical and easy to assemble. It is only necessary to pre-mount the assembly of the valve and to incorporate this then directly. The valve according to the invention is also readily scalable because of its low constructional space requirement.

With the valve according to the invention, it is possible in particular, even with only small available constructional spaces, for example with very limited cross-sections, to enable a double function of the opening in one direction and of the bypass in the other direction. Hence the valve also fulfils both requirements that, on the one hand, with a positive pressure, a bypass/high-pressure opening is made possible in one direction and, on the other hand, also a non-return/blocking function.

The opening element can advantageously be a through-opening in the valve plate which is closed by a flap. The flap thereby opens in a direction counter to the opening direction of the valve plate. The flap can thereby be mounted for example rotatably. The axis of rotation is then situated preferably at the side neighboring to the flap.

In another embodiment of the opening element, one or more slot-shaped openings are provided in the valve plate. In the case of high pressure on one side of the valve, the valve plate is deformed so that through-openings for the gases are formed along the slots. The slot-shaped through-openings can thereby be linear, meandering, in the form of circular sections or the like. Advantageously, one or more of such slot-shaped openings are provided. These can then extend at least partially parallel or concentrically relative to each other.

Advantageously, such slot-shaped openings are disposed essentially in edge regions of the valve plate, for example in regions which are removed from the surface centre of the valve plate by more than 50% of the radial extension. If the slot-shaped through-holes are now supported on one side by a bearing element, then the opening element which has these slot-shaped openings can open only in the other direction. Hence the opening element becomes a non-return valve which enables passage merely in one direction.

This bearing element can for example be configured in annular shape, in particular an entirely or extensively circular shape. Such a bearing element then is in particular configured in a circular shape if also the slot-shaped openings are configured correspondingly as circular sections.

The valve plate itself can have an outer contour which has an oval, elliptical, circular or other type of shape.

On the one hand, the opening of the opening element can be blocked entirely in one direction by the bearing element, on the other hand, by a suitable stopper, for example one or more webs, the degree of opening of the opening element can be delimited in the other direction.

This stopper is advantageously disposed, with respect to the gas flow direction in the case of an opened opening element, gas-flow-downwards or on the negative pressure side relative to the opening element. It forms a bearing for the opening element in the maximum opened state of the opening element. As a result, the opening element is mounted well and in a stable manner on the suction-side in the maximum opened state.

This bearing can have in particular a single web, a plurality of webs and in particular webs which intersect or converge to form a star or consist thereof. Advantageously, the region of the connection of the webs with each other is disposed such that the opening element is mounted in the centre/moment-free on this region in the maximum opened state.

As a result of this mounting of the opening element, described as advantageous, gas-flow-downwards/on the suction-side relative to the opening element, in particular deformation of the opening element in the maximum opened state is prevented or reduced and thus also the opening behaviour of the opening element or the throughflow cross-section which is uncovered at maximum by the opening element can be determined or established exactly.

The opening characteristic and the degree of opening of the opening element is established further by the number, shape and arrangement of the slot-shaped openings or of the flap. The degree of opening of the opening element is determined by the bearing element. In the case of laterally lifting flaps, delimitation to an opening angle≦85°, preferably ≦60°, is advantageous for simple reclosure. In the case of opening elements with slot-shaped openings, the stopper ensures that the opening element is deformed only within the elastic range thereof.

Similarly, by means of the spring characteristic of the resilient mounting of the valve closure on the valve bearing, the opening characteristic of the valve plate and hence of the valve opening is determined.

Advantageously, the valve plate consists of a metal sheet, in particular a steel sheet, particularly preferably of a tempered steel sheet or comprises this. In particular the opening element, which is element of the valve plate for its part, can also be manufactured from other materials. However, manufacture of the valve completely from metal is advantageous since a fully-metallically manufactured valve is subject to fewer restrictions with respect to the permissible temperature, i.e. is more temperature-resistant, and in addition has greater resistance relative to oils.

The valve in total, the bearing element and further elements of the valve can also consist of a plastic material, in particular of a thermoplastic plastic material, preferably of a polyamide, preferably polyamide 6.6, or comprise these materials even if the valve plate consists of a metallic material or comprises this.

The connection between the individual elements, for example the connection between the bearing element and an annular element bearing the stopper, with intermediate mounting of the edge region of the valve plate, can be produced in particular by means of a clip connection or by means of welding, ultrasonic welding, vibration welding or hot-gas welding.

Preferably, a metallic spiral spring or a pretentioned elastomeric column are suitable for the valve bearing. With both, a resilient elastic mounting of the valve plate with the required pretension can be achieved.

A liquid separator according to the invention now has a valve according to the invention and can be incorporated in a ventilation system according to the invention and in an internal combustion engine according to the invention.

Subsequently, a few examples of valves according to the invention are now given. The same or similar reference numbers in the various Figures thereby always denote the same or similar elements so that explanation thereof is in part not repeated. The subsequent examples respectively have a large number of different optional features of the valve according to the invention, alone or also in combination with each other. These features according to the invention can however, also in a different combination or even per se separately, develop the valve according to the invention.

There are shown

FIGS. 1 and 2 an internal combustion engine according to the state of the art in coasting operation and full-load operation;

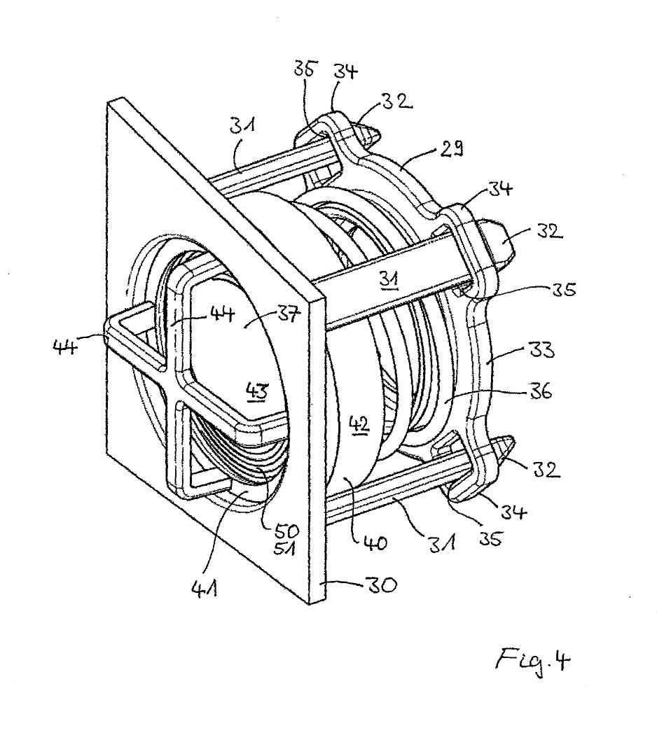

FIG. 3 an internal combustion engine according to the invention;

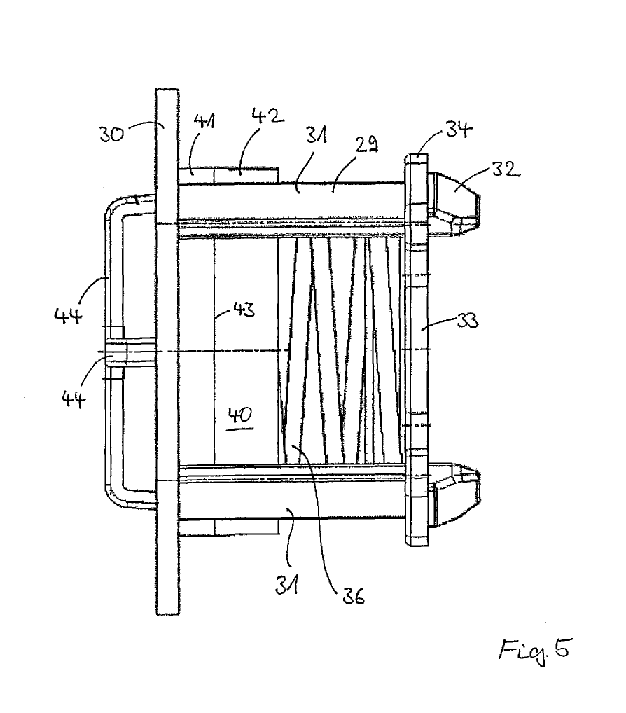

FIG. 4 an embodiment of a valve according to the invention in side plan view;

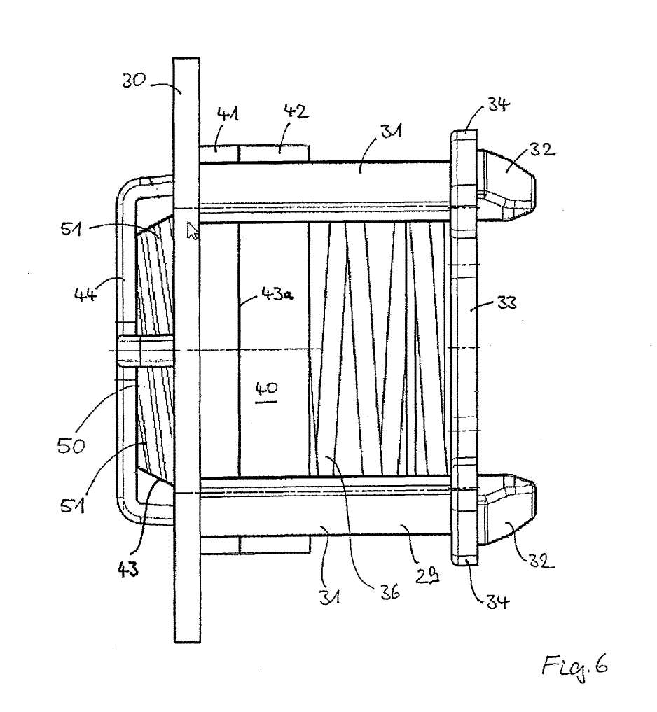

FIG. 5 to FIG. 9 plan views or sectional views of the valve according to the invention;

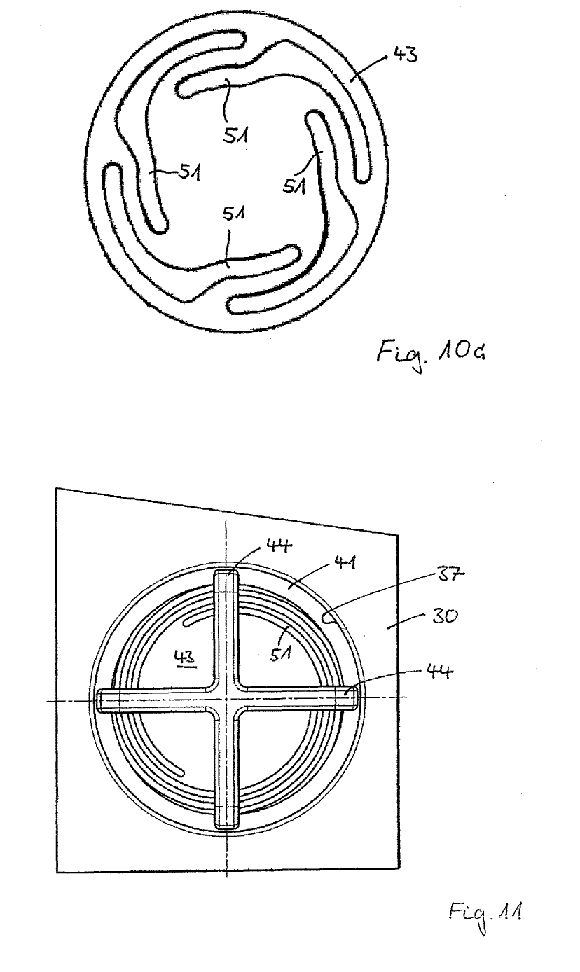

FIGS. 10a to 10c different embodiments of a valve plate of a valve according to the invention;

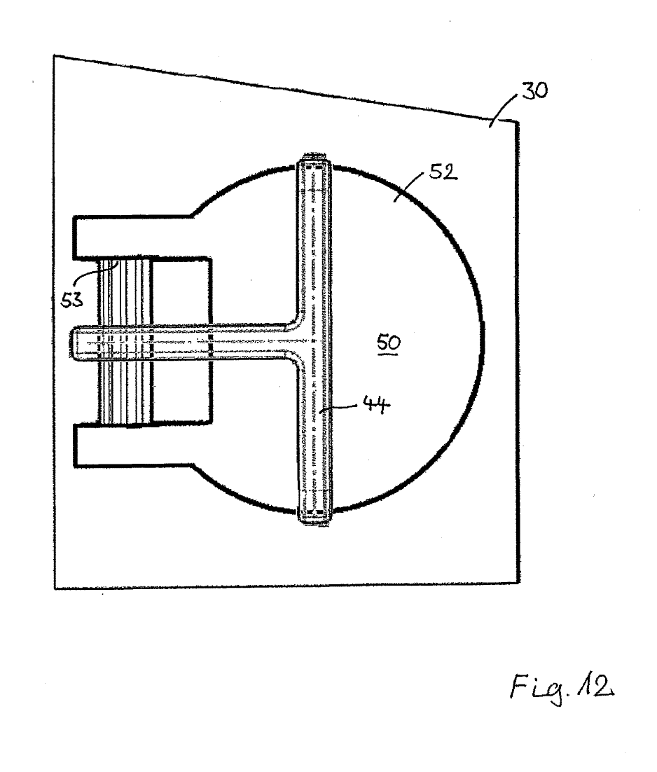

FIG. 11 a plan view on a valve according to the invention;

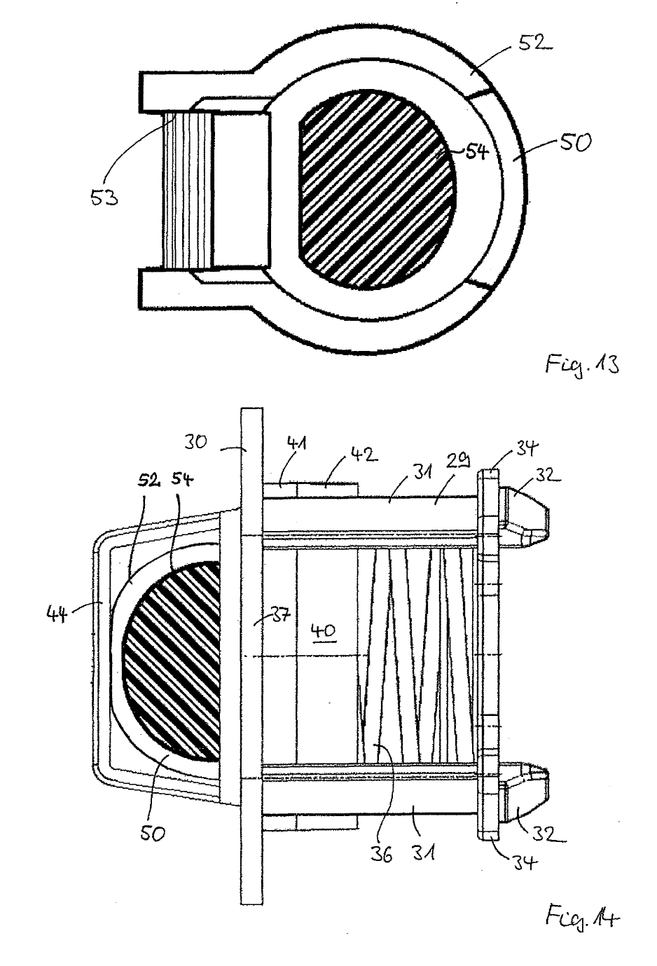

FIG. 12 a further plan view on a section of a valve according to the invention;

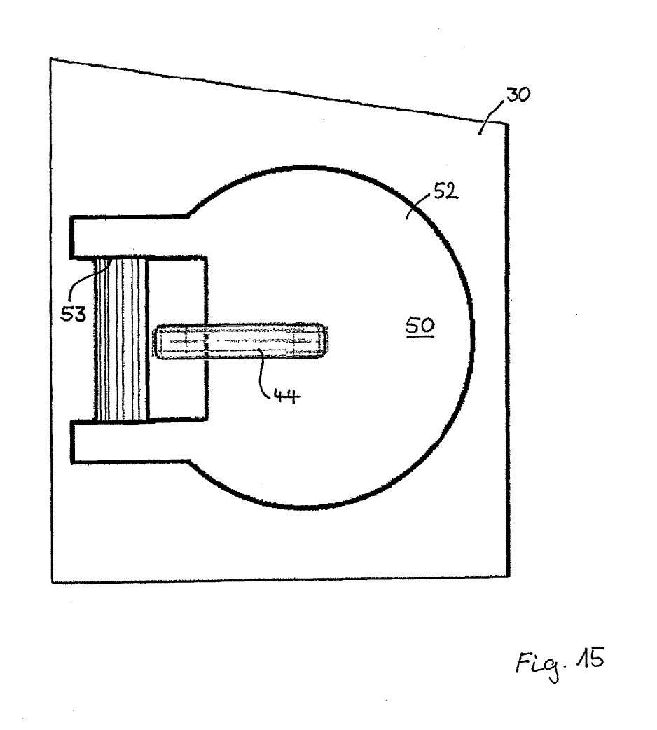

FIG. 13 a view from below of a section of a valve according to the invention;

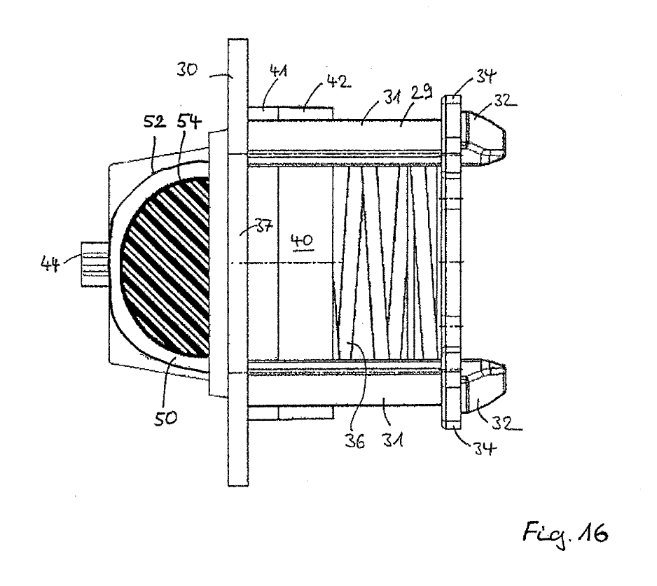

FIG. 14 a side plan view on a valve according to the invention;

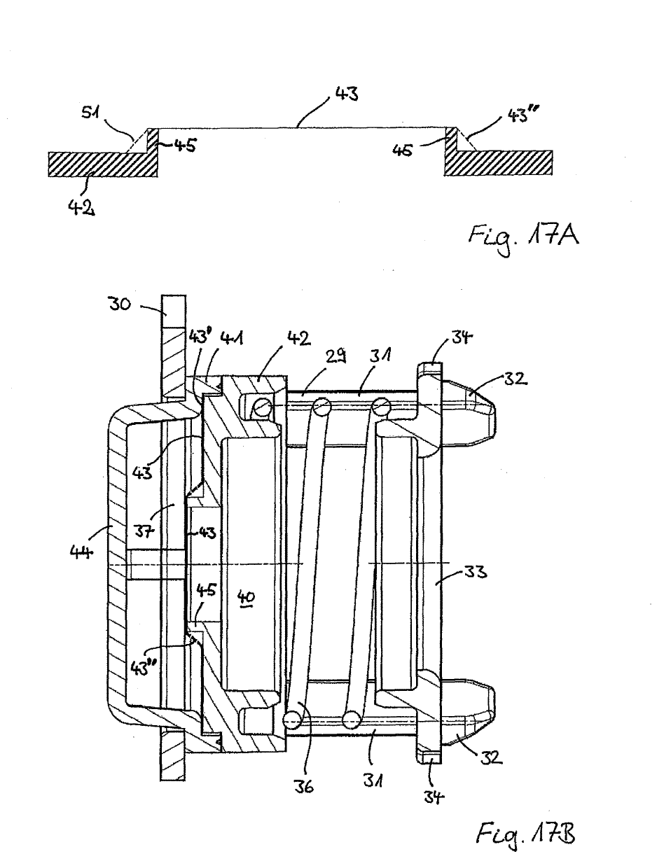

FIG. 15 a top view on a section of a valve according to the invention;

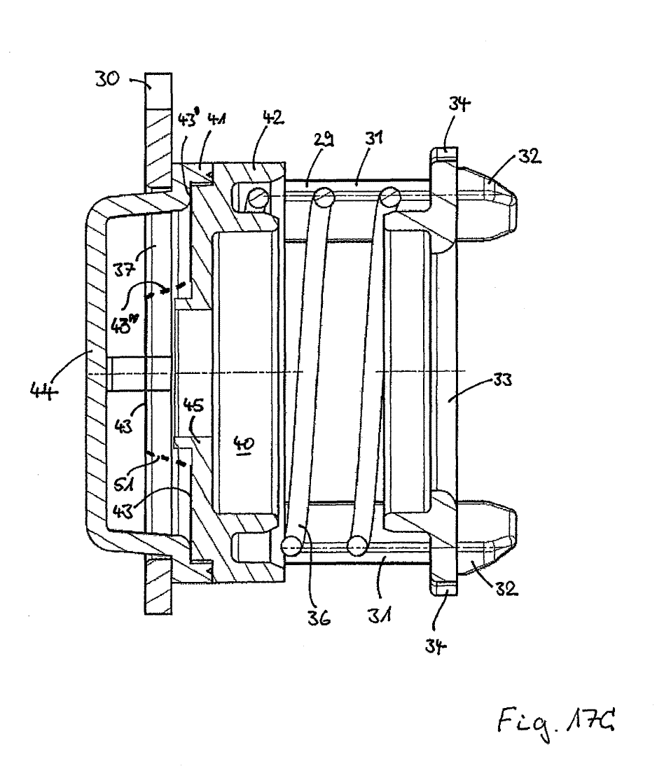

FIG. 16 a side plan view on a valve according to the invention;

FIG. 17 in three partial FIGS. 17A, 17B and 17C, a further valve according to the invention.

FIG. 3 shows an internal combustion engine 1 according to the invention. This internal combustion engine is constructed in the same way as that in FIGS. 1 and 2. In contrast to the internal combustion engine in FIGS. 1 and 2, this however does not have two valves 27 and 28 but rather one valve 29 according to the invention which extends over the separation wall 30. The separation wall 30 is thereby itself part of the valve 29 insofar as it forms the valve opening 37 of the valve 29.

The valve 29 is now configured such that, during coasting operation of the engine, it opens in the direction of the chamber 24 and consequently makes possible a gas flow via the pipe 15, the chamber 26, the separator 23 and the valve 29 towards the chamber 24 and then, from there together with the blow-by gases, via the oil separator 22 and the chamber 25 and also the pipe 16 into the intake pipe 12c.

In the case of full load, a high pressure is present behind the throttle valve 14 in the region 12c of the intake pipe 12. Therefore, the gas flow, in particular fresh air, now flows via the pipe 16 with the pressure control valve 18, the chamber 25, the separator 22 towards the chamber 20 and, from there together with the blow-by gases, via the valve 29, the separator 23, the chamber 26 and the pipe 15 into the intake pipe 12 in section 12a. The valve 29 is therefore opened in the direction of the chamber 26.

FIG. 4 shows a side plan view on a valve 29 according to the invention. This valve 29 has a valve opening 37 which is disposed in a portion of the separation wall 30. This portion of the separation wall 30 can be regarded as belonging to the valve. It is however also possible to provide the valve opening in a separate component which can be inserted in an opening of the separation wall 30. The valve opening 37 is closed by a valve closure which is formed from a first annular element 41, a valve plate 43 and a second annular element 42. Both annular elements 41 and 42 enclose, between each other, the circumferential edge of the valve plate 43 and therefore secure this. The valve closure consisting of these three elements is now mounted resiliently on a spring 36 and a valve bearing 33. With sufficient pressure on the valve plate 43 (from the left in the drawing), the valve closure is therefore pressed counter to the spring force in the direction of the bearing 33 and hence uncovers the valve opening 37.

The valve bearing 33 is secured on the separation wall 30 via retaining elements 31. Should an individual element be provided in order to form the valve opening, securing on this element is then effected via the retaining elements 31. For simpler assembly, the retaining elements 31 have catch lugs 32. Corresponding to these catch lugs 32, the valve bearing 33, which can be configured for example as base plate, has projections 34 with catch openings 35. As a result, the valve bearing 33 can be mounted easily on the retaining elements 31. The separation wall 30 and/or the retaining elements 31 can in general be for example part of a housing or of a wall, for example of a housing or wall of a valve cover, an oil separator module, an oil sump, a front cover or the like.

According to the invention, the valve plate now has an opening element 50. This opening element 50 includes slots 51 which enable opening. These slots are covered on the rear-side by the ring element 42, not detectable in FIG. 4. High pressure on sides of the second annular element 42 opposite the side of the annular element 41 consequently leads to deflection of the central part of the valve plate 43 so that the slots 51 are opened and annular gaps are uncovered. Consequently, a bypass function from the side of the second annular element 42 to the side of the first annular element 41 is produced. This bypass function makes it possible for gases to be able to flow through the valve counter to the actual opening direction of the valve.

For opening of the valve by lifting of the valve closure from the valve opening 37 counter to the pretension of the spring 36, in particular differential pressures of 0 to 500 mbar, preferably 0 to 100 mbar, are suitable. For opening of the opening element by widening the slots 51, pressure differences between pressure and suction-side of 0 to 500 mbar, preferably 0 to 200 mbar, are suitable. These values are basically preferred values for every valve according to the invention and apply excluding or also including the respective range limits.

The first ring 41 has furthermore hoops or webs 44 disposed in a cross-shape. These webs extend firstly vertically and then horizontally over the valve plate 43 and—in the rest position thereof—are at a spacing from the valve plate 43. If now the valve plate 43 is deformed by high pressure on sides of the second annular element 42 and the slots 41 are thereby widened, then the webs 44, which are disposed, in the opened state of the valve plate 43, gas-flow-downwards or on the suction-side relative to the throughflow direction, serve as stoppers for opening the valve plate, they ensure that the valve plate is deformed only within the elastic range.

FIG. 5 shows a side plan view on the same valve as in FIG. 4. In this view, it can be readily detected that the valve plate 40 is formed by the first annular element 41 and the second annular element 42 and also by the valve plate 43 which is mounted between these two annular elements and by these two annular elements.

FIG. 5 thereby shows a state in which, on the one hand, the valve opening is closed and, on the other hand, also the valve plate is not deflected.

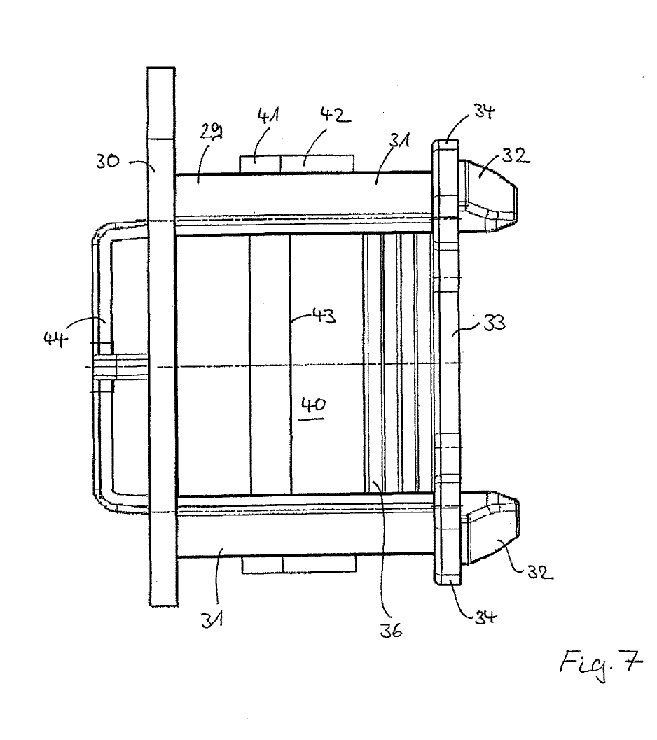

FIG. 6 shows a state of the same valve as in FIG. 4 and FIG. 5. In FIG. 6, the valve plate 43 is now however deflected such that it abuts against the stopper webs 44. The slots 51 uncover the flow path. As a result, a gas passage from the right-hand side in the drawing towards the left-hand side in the drawing is now possible. The valve opening 37 itself is furthermore closed as such by the valve closure 40, i.e. the connection of both annular elements 41, 42 and valve plate 43 mounted therebetween.

FIG. 7 shows the same valve as in FIGS. 4 to 6. Now however, the valve closure is displaced by high pressure on sides of the first annular element 41 counter to the pretension force of the spring 36 in the direction of the valve bearing 33. Consequently, the valve opening is now uncovered annularly so that gases from the left-hand side in the drawing can flow towards the right-hand side in the drawing through the valve opening.

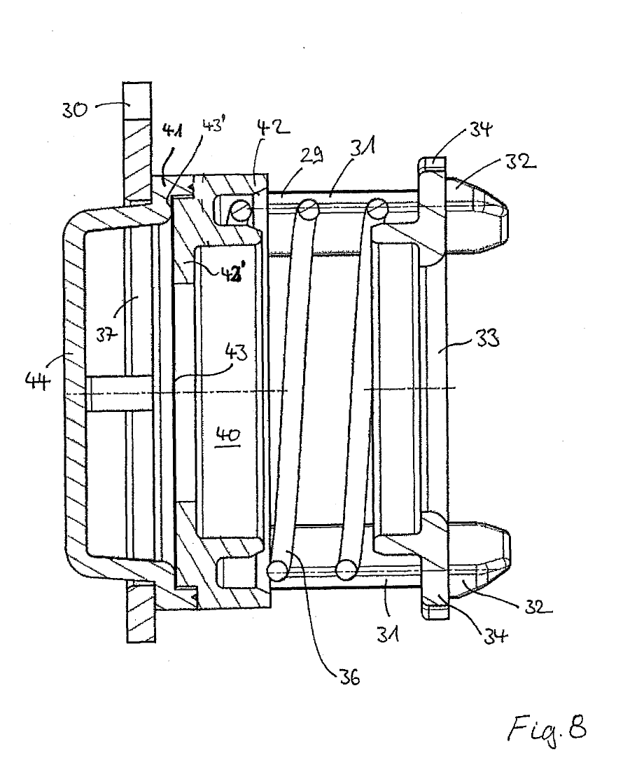

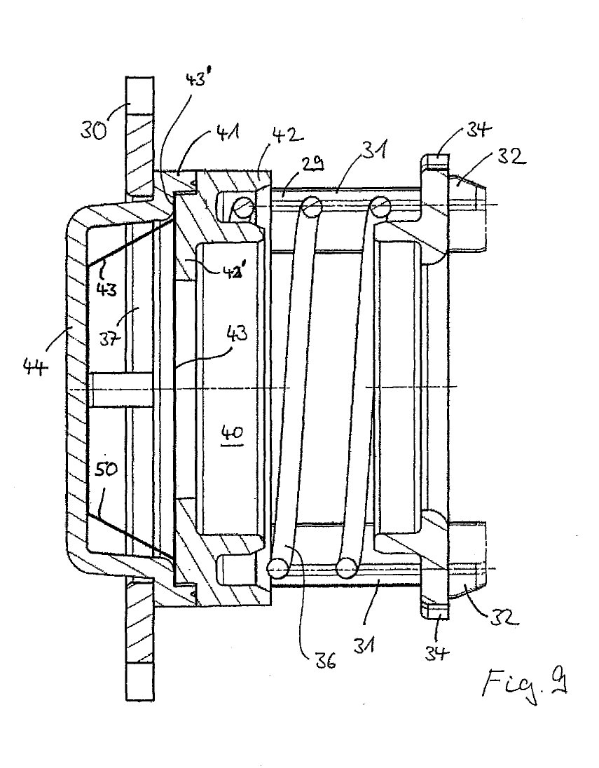

FIG. 8 shows a section through the valve according to FIGS. 4 to 7. It can be readily detected hereby how the valve plate 43 is clamped and mounted at its edges between the first annular element 41 and the second annular element 42. FIG. 8 thereby shows the valve in a state in which both the valve opening 37 is closed and the opening elements in the valve plate 43 are not widened.

In FIG. 8, that region of the valve plate 43, which is mounted clamped between the first annular element 41 and the second annular element 42, is provided with the reference number 43′. Furthermore, that region of the second annular element 42, on which the valve plate 43 is supported in FIG. 8, is provided with the reference number 42′. In the region of this support region 42′, the slot-shaped openings 51 are disposed in the valve plate 43, whilst no slot-shaped openings 51 are provided outside this region. As a result, in the case of high pressure on sides of the first annular element 41 relative to the second annular element 42, the valve plate cannot be widened. The valve plate 43 with the opening elements thereof therefore forms a non-return valve.

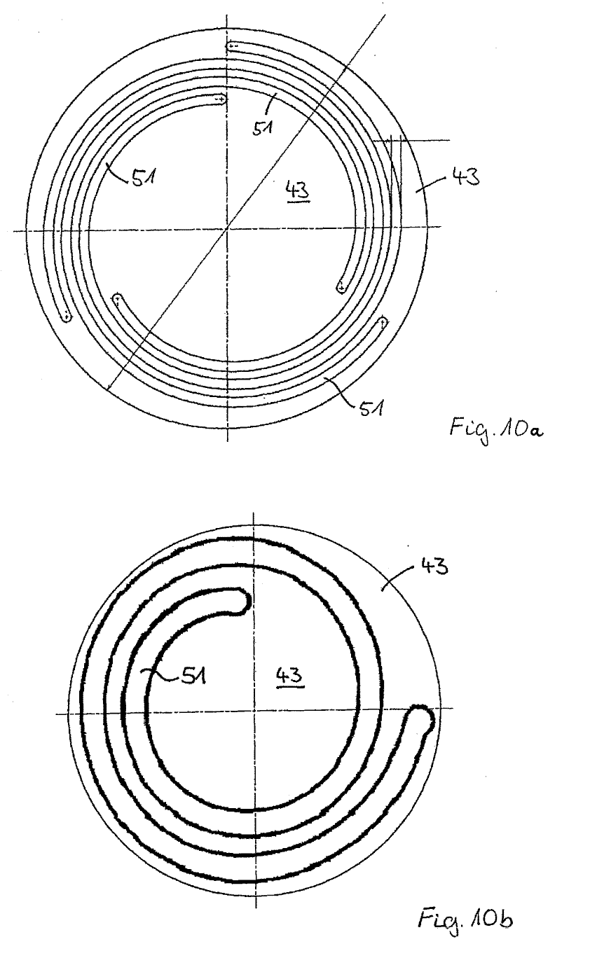

FIG. 9 shows the same valve as in FIG. 8, now however in a state in which a high pressure prevails on sides of the second annular element 42 relative to the side of the first annular element 41. The valve plate 43 is now widened in the direction of the stopper webs 44 and abuts against these. Consequently, the slots are widened in the edge region of the valve plate 43 and uncover annular gaps for the throughflow by gases.

FIGS. 10a to 10c show different variants of opening elements.

In FIG. 10a, the slot-shaped openings are present in a plurality, namely three here, which are disposed concentrically in the shape of circular sections. In FIG. 10b, a single slot which extends helically over in total 1¾ circles is provided. In FIG. 10c, in total four slot-shaped openings 41 which are disposed offset relative to each other are provided.

It is common to all these opening elements that they are disposed in the outer region of the valve plate 43 so that the central region of the valve plate 43 remains closed and can lift as such out of the plane of the valve plate with suitable pressure conditions. The outer region of the valve plate is thereby blocked in the mounted state such that an opening counter to the opening direction from the first to the second side of the valve is not possible. FIG. 11 shows a plan view on the valve for example according to FIG. 9 and FIG. 10a. It can be detected here that the central region of the valve plate 43 is not pierced. The annular slots 51 are merely provided in those regions at the edge of the valve plate 43 in which they are covered and supported by the second annular element 42 below the drawing plane.

FIG. 12 now shows a further embodiment of an opening element 50. FIG. 12 thereby shows a plan view on the valve as in FIG. 11. Now however, the stopper webs 44 are disposed in a T-shape. The opening element 50 is disposed in the drawing plane below the stopper webs 44. This opening element 50 has a flap/closure element 52. This flap 52 is mounted rotatably on a bearing 53. The stopper webs 44 have the effect here that the flap 52 can be opened by at most 45°.

FIG. 13 shows a view from below of this rotatably mounted opening element 50. The flap 52 which is mounted in the rotary bearing 53 now has a rubber support 54 on the lower side. This rubber support 54 is configured such that it completely covers an opening in the valve plate. Instead now therefore of deforming the entire valve plate in order to widen slot-shaped opening elements, as in the previous embodiments, now opening of the flap 52 about the rotary hearing 53 thereof is effected with suitable pressure conditions.

FIG. 14 shows a side plan view on the entire valve which is basically configured just like the valve in FIG. 4. Merely the opening element 50 of the valve plate is now configured as flap 52. FIG. 14 thereby shows a state in which the flap 52 is opened and abuts against the stopper webs 44. Consequently, it delimits the opening angle of the flap 52.

FIG. 15 now shows a further valve in plan view. Merely the section of the opening element 50, more precisely the valve flap 52, is thereby illustrated. In contrast to the flap 52, in FIG. 12, only a single stopper web 44 is provided, which web is configured as a freely projecting bar and is anchored in one piece, with and in the annular element 41. It is supported at its left side on the first annular element 41. Its right-hand end is free and serves as limit stop for the flap 50 during opening thereof. As a result, opening of the flap by at most 60° is made possible so that also closing the flap again does not present any difficulty.

FIG. 16 shows a plan view on a valve which has a flap as in FIG. 15. The valve is thereby illustrated in a state in which high pressure prevails on sides of the second annular element, compared with the first annular element, so that the flap 50 is opened and abuts on the projecting stopper web 44.

FIG. 17 shows, in three partial Figures, a further embodiment of a valve 29 according to the invention. Here the valve plate 43 is pretensioned counter to its closing direction. FIG. 17A illustrates a cross-section through the closed valve plate 43 together with the second annular element 42. The annular element 42 here has a gradation/gradated region 45 via which the valve plate 43 is pretensioned. The gradated regions 45 form a circumferential edge for a through-opening 46 within and through the second annular element 42. Those regions 43″ of the valve plate 43, which have slot-shaped openings 51, extend oblique to the plane of the valve plate 43 within this opening.

FIG. 17B shows the incorporation situation of this—likewise closed here—valve plate 43 in a valve analogously to FIG. 8. As in FIG. 17A, the gradation 43″ can be detected, via which the slotted regions of the valve plate 43 are pretensioned in the direction of the annular element 41 via the other plane of the annular element 42.

FIG. 17C shows the valve of FIG. 17B now in the opened state, the valve plate, by applying high pressure or gas volume flow from the direction of the spring element 36, being lifted from the gradated region 45 and the slot-shaped openings 51 being widened and opened. By means of the pretension of the valve plate over the gradated region 45, displacement of the opening point of the valve at for example 10 mbar as far as higher pressure differences can be achieved. When applying a high pressure from the side of the webs 44, the valve plate is however not deflected so far in the direction of the spring 36 that the slot-shaped openings 51 would uncover a passage for gases through the slot-shaped openings 51 and through the opening 46 between the gradated regions 45.

1-22. (canceled)

23. A valve for controlling a gas flow between a first side and a second side of the valve, with
a valve opening as passage for the gas flow between the first side and the second side,
a valve closer with a valve plate for closing the valve opening, and
a valve bearing which is disposed towards the second side and on which the valve closer, for closing the valve towards the second side by the valve plate, is mounted resiliently, pretensioned in direction of the first side, wherein
the valve plate has an opening element which is openable towards the first side with high pressure on the second side.

24. The valve according to claim 23, wherein the opening element has a through-opening closed by a flap, the flap, with high pressure on the second side, being mounted either rotatably in the direction of the first side and/or able to be lifted from the plane of the valve plate in or on the valve closer.

25. The valve according to claim 23, wherein the valve plate has one or more slot-shaped openings as the opening element, which can be widened with high pressure on the second side towards the first side.

26. The valve according to claim 25, wherein at least one of the slot-shaped openings extends linearly, meander-shaped or in the form of a circular section.

27. The valve according to claim 25, wherein said slot-shaped openings extend parallel or concentrically relative to each other.

28. The valve according to claim 25, wherein the slot-shaped openings are disposed exclusively in regions which are removed from the centroid of the area of the valve plate by more than 50% of the radial extension.

29. The valve according to claim 25, wherein the valve opening is determined with high pressure on the second side, by the number, shape and arrangement of the slot-shaped openings.

30. The valve according to claim 23, wherein the valve closure has at least one bearing element which prevents opening of the opening element towards the second side.

31. The valve according to claim 30, wherein the bearing element is configured in an annular shape.

32. The valve according to claim 30, wherein the bearing element is disposed starting from the valve plate towards the second side, covers the valve plate in the region of the slot-shaped openings and forms a limit stop for the valve plate.

33. The valve according to claim 23, wherein the valve plate, with respect to the outer contour thereof, has an oval, elliptical or circular shape.

34. The valve according to claim 31, wherein the valve has a stopper on the first side, wherein the stopper delimits the degree of opening of the opening element.

35. The valve according to claim 34, wherein the stopper has one, two or multiple webs which extend on the first side adjacent to the valve plate at least in regions over the valve plate, the webs at a spacing relative to the opening element when the opening element is closed.

36. The valve according to claim 35, wherein the stopper and/or the webs are configured as continuations of an annular element.

37. The valve according to claim 23, wherein an opening characteristic of the valve is determined by a spring characteristic of the valve bearing with high pressure on the first side.

38. The valve according to claim 23, wherein the valve plate is constructed of a material selected from the group of metal sheet, steel sheet, and spring-tempered steel sheet or comprises these.

39. The valve according to claim 23, wherein the valve plate is constructed of a material selected from the group of a plastic material, a 2-component plastic material with a thermoplastic and an elastomeric component, the elastomeric component, in the closed state of the valve plate, pointing towards the second side.

40. The valve according to claim 23, wherein the valve bearing is constructed of a material selected from the group of a metallic spiral spring or a pretensioned elastomeric column or comprises these.

41. The valve according to claim 36, wherein the valve and/or the bearing element and/or the annular element are constructed of a material selected from the group of a plastic material, a thermoplastic plastic material, a polyamide, and polyamide 6.6 or comprise these materials.

42. The valve according to claim 36, wherein the bearing element and the annular element are connected to each other with structures selected from the group of intermediate mounting of an edge region of the valve plate, a clip connection, welding, ultrasonic welding, vibration welding or hot-gas welding.

43. The valve according to claim 23, wherein liquids from blow-by gases from the gas flow of an internal combustion engine is separated.

44. The valve according to claim 23, wherein the valve is connected to a ventilation pipe, from a crankcase to an intake duct of an internal combustion engine.
